(19) United States
(12) Patent Application Publication
(10) Pub. No.: US 2019/0252768 A1
(43) Pub. Date: Aug. 15, 2019

(54) ANTENNA MODULE AND ELECTRONIC DEVICE HAVING THE SAME

(71) Applicant: Samsung Electro-Mechanics Co., Ltd., Suwon-si (KR)

(72) Inventors: Hee Seung KIM, Suwon-si (KR); Soon Joung YIO, Suwon-si (KR); Jae Hyuk JANG, Suwon-si (KR); Jae Sun WON, Suwon-si (KR); Young Seung ROH, Suwon-si (KR); Jae Gen EOM, Suwon-si (KR)

(73) Assignee: Samsung Electro-Mechanics Co., Ltd., Suwon-si (KR)

(21) Appl. No.: 16/008,110

(22) Filed: Jun. 14, 2018

(30) Foreign Application Priority Data
Feb. 14, 2018 (KR) 10-2018-0018720

(51) Int. Cl. H01Q 1/38; H01Q 7/00; H01Q 1/24; H04M 1/02; H04B 5/00; H02J 50/10; H02J 7/02

(52) U.S. Cl. CPC H01Q 1/38; H01Q 7/00; H01Q 1/243; H04M 1/0262; H01R 2201/02; H04B 5/0081; H02J 50/10; H02J 7/025; H04B 5/0037

(57) ABSTRACT

An antenna module includes an insulating substrate; and communications wiring disposed on opposite surfaces of the insulating substrate and including a spiral wiring formed by a first spiral wiring disposed on a first surface of the insulating substrate and a second spiral wiring disposed on a second surface of the insulating substrate, wherein the spiral wiring includes a plurality of coil strands spaced apart from each other and not electrically connected to each other within the spiral wiring, and the communications wiring further includes a connecting part electrically connecting the plurality of coil strands to each other outside the spiral wiring.

### CROSS-REFERENCE TO RELATED APPLICATION

This application claims the benefit of Korean Patent Application No. 10-2018-0018720 filed on Feb. 14, 2018, in the Korean Intellectual Property Office, the entire disclosure of which is incorporated herein by reference for all purposes.

### BACKGROUND

### 1. Field

This application relates to an antenna module and an electronic device having the same.

### 2. Description of Related Art

Portable terminals have recently been implemented with the capability of performing various functions such as wireless power reception for wirelessly receiving power to charge batteries of the portable terminals, radio frequency identification (RFID), near-field communication (NFC), and magnetic secure transmission (MST).

Such functions are performed using an antenna having a coil shape. Different functions use different antennas, and as a result, a plurality of antennas are mounted in the portable terminal to perform the different functions.

However, there is also a demand for decreasing the thickness of a portable terminal, and as the thickness of the portable terminal decreases, it becomes more and more difficult to mount the plurality of antennas in the portable terminal while maintaining a high efficiency of the plurality of antennas.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an antenna module includes an insulating substrate; and communications wiring disposed on opposite surfaces of the insulating substrate and including a spiral wiring formed by a first spiral wiring disposed on a first surface of the insulating substrate and a second spiral wiring disposed on a second surface of the insulating substrate, wherein the spiral wiring includes a plurality of coil strands spaced apart from each other and not electrically connected to each other within the spiral wiring, and the communications wiring further includes a connecting part electrically connecting the plurality of coil strands to each other outside the spiral wiring.

The communications wiring may further include a connection pad; and a lead wiring connecting an outer end portion of the spiral wiring to the connection pad, and the connecting part may be disposed within the lead wiring.

The coil strands of the first spiral wiring and the coil strands of the second spiral wiring may be respectively connected to each other through interlayer connection conductors disposed in the insulating substrate.

The coil strands of the first spiral wiring and the coil strands of the second spiral wiring may be connected to each other in opposite order in a diameter direction of the spiral wiring.

A coil strand disposed in an innermost position in each turn of the first spiral wiring among the coil strands of the first spiral wiring may be connected to a coil strand disposed in an outermost position of each turn of the second spiral wiring among the coil strands of the second spiral wiring.

The coil strands of an innermost turn of the first spiral wiring and an innermost turn of the second spiral wiring may be dispersed on the first surface and the second surface of the insulating substrate.

One or more of the coil strands of the innermost turns may be disposed on both the first surface and the second surface of the insulating substrate and may be connected to each other in parallel.

A line width of the coil strands connected to each other in parallel may be narrower than a line width of remaining ones of the coil strands.

An overall width of the first spiral wiring may be equal to an overall width of the second spiral wiring.

The antenna module may further include a magnetic portion disposed on one surface of the insulating substrate, and the connecting part may be disposed in a position that does not face the magnetic portion.

One or more turns of the first spiral wiring and one or more turns of the second spiral wiring may be connected to each other in parallel.

An innermost turn of the first spiral wiring and an innermost turn of the second spiral wiring may be connected to each other in parallel, and an outermost turn of the first spiral wiring and an outermost turn of the second spiral wiring may be connected to each other in parallel.

A line width of the coil strands of the turns of the first spiral wiring and the second spiral wiring connected to each other in parallel may be narrower than a line width of the coil strands of remaining turns of the first spiral wiring and the second spiral wiring.

In another general aspect, an electronic device includes a wiring portion including communications wiring disposed on opposite surfaces of an insulating substrate; and a magnetic portion coupled to one surface of the wiring portion, wherein the communications wiring includes a spiral wiring including a plurality of coil strands spaced apart from each other; and a connecting part electrically connecting the coil strands to each other and disposed at a position where the connecting part does not face the magnetic portion.

The spiral wiring may be formed by a first spiral wiring disposed on a first surface of the insulating substrate and a second spiral wiring disposed on a second surface of the insulating substrate, an inner end portion of the first spiral wiring and an inner end portion of the second spiral wiring may be connected to each other through an interlayer connection conductor disposed in the insulating substrate, and the communications wiring may further include a first connection pad; a second connection pad; a first lead wiring connecting an outer end portion of the first spiral wiring to the first connection pad; and a second lead wiring connecting an outer end portion of the second spiral wiring to the second connection pad.

An innermost turn of the first spiral wiring and an innermost turn of the second spiral wiring may connected to each other in parallel.

In another general aspect, an antenna module includes an insulating substrate; and a plurality of coil strands forming a spiral wiring on the insulating substrate beginning on a first surface of the insulating substrate and ending on a second surface of the insulating substrate, the plurality of coil strands not being electrically connected to each other within the spiral wiring and being electrically connected to each other outside the spiral wiring.

The spiral wiring may include a first spiral wiring disposed on the first surface of the insulating substrate; and a second spiral wiring disposed on the second surface of the insulating substrate, the antenna module may further include interlayer connection conductors disposed in the insulating substrate and electrically connecting inner end portions of the plurality of coil strands of the first spiral wiring to inner end portions of the plurality of coil strands of the second spiral wiring; a first connection pad; a second connection pad; a first lead wiring electrically connecting outer end portions of the plurality of coil strands of the first spiral wiring to the first connection pad; and a second lead wiring electrically connecting outer end portions of the plurality of coil strands of the second spiral wiring to the second connection pad, wherein either the first connection pad may electrically connect the plurality of coil strands of the first spiral wiring to each other, and the second connection pad may electrically connect the plurality of coil strands of the second spiral wiring to each other, or the first lead wiring may include a first connecting part electrically connecting the plurality of coil strands of the first spiral wiring to each other in the first lead wiring, and the second lead wiring may include a second connecting part electrically connecting the plurality of coil strands of the second spiral wiring to each other in the second lead wiring.

A number of turns of the first spiral wiring may equal to a number of turns of the second spiral wiring, an outer periphery of the first spiral wiring may align with an outer periphery of the second spiral wiring through the insulating substrate, and an inner periphery of the first spiral wiring may align with an inner periphery of the second spiral wiring through the insulating substrate.

The antenna module may further include a magnetic portion disposed on the first surface or the second surface of the insulating substrate or facing the first surface or the second surface of the insulating substrate, and the plurality of coil strands may be electrically connected to each other outside the spiral wiring at a position that does not face the magnetic portion.

Other features and aspects will be apparent from the following detailed description, the drawings, and the claims.

### BRIEF DESCRIPTION OF DRAWINGS

FIG. 1 is a perspective view schematically illustrating an example of an electronic device.

FIG. 2 is a cross-sectional view taken along a line I-I′ of FIG. 1.

FIG. 3 is a plan view schematically illustrating a first surface of an example of an antenna module.

FIG. 4 is a plan view schematically illustrating a second surface of the example of the antenna module illustrated in FIG. 3.

FIG. 5 is a plan view schematically illustrating a first surface of another example of an antenna module.

FIG. 6 is a plan view schematically illustrating a second surface of the antenna module illustrated in FIG. 5.

FIG. 7 is a plan view schematically illustrating a first surface of another example of an antenna module.

FIG. 8 is a plan view schematically illustrating a second surface of the antenna module illustrated in FIG. 7.

FIG. 9 is a plan view schematically illustrating a first surface of another example of an antenna module.

FIG. 10 is a plan view schematically illustrating a second surface of the antenna module illustrated in FIG. 9.

FIG. 11 is a plan view schematically illustrating a first surface of another example of an antenna module.

FIG. 12 is a plan view schematically illustrating a second surface of the antenna module illustrated in FIG. 11.

FIG. 13 is an enlarged view illustrating portions A and B of FIGS. 11 and 12.

FIG. 14A and FIG. 14B are graphs illustrating examples of simulations of current density in a spiral wiring.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

An electronic device described in this application may be a cellular phone or a smartphone. However, the electronic device is not limited thereto, but may be any electronic device that may be carried and has the capability of performing wireless communications, such as a notebook, a tablet PC, or a wearable device.

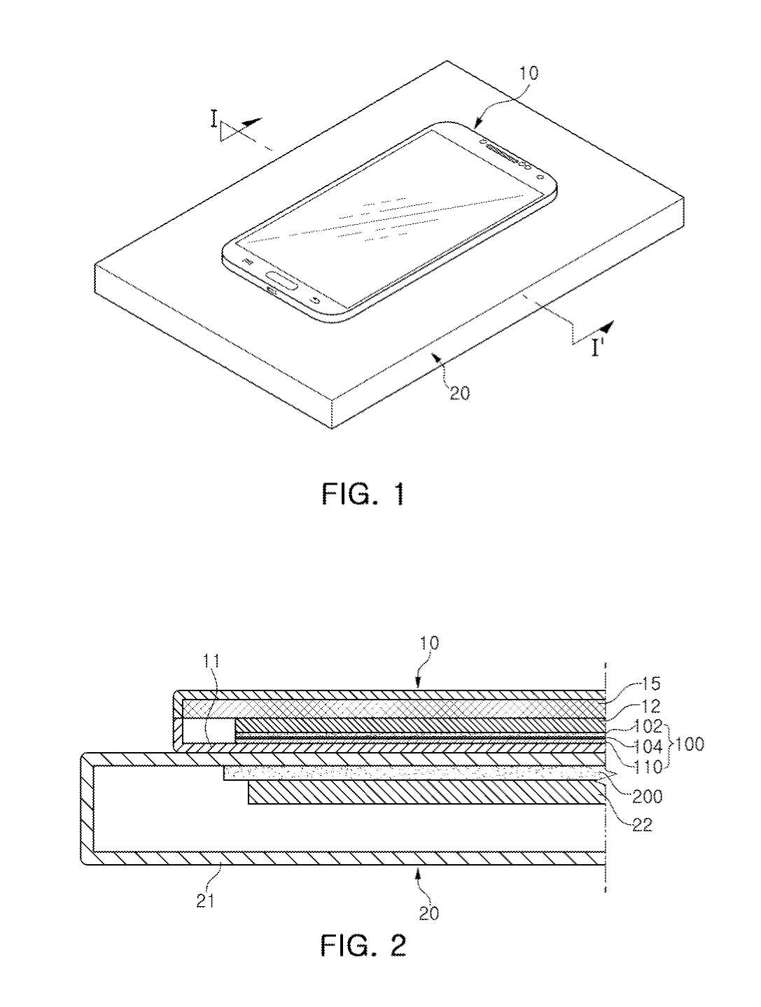

FIG. 1 is a perspective view schematically illustrating an example of an electronic device, and FIG. 2 is a cross-sectional view taken along a line I-I′ of FIG. 1.

Referring to FIGS. 1 and 2, the electronic device may be a wireless charging device 20 that wirelessly transmits power, or a portable terminal 10 that wirelessly receives the power and charges a battery of the portable terminal 10 with the received power.

The portable terminal 10 includes a terminal body 15, a cover 11, a battery 12, and an antenna module 100. The antenna module 110 includes a magnetic portion 102, an adhesive part 104, and a wiring portion 110.

The cover 11, which is a rear cover coupled to the terminal body 15 to complete the portable terminal 10, may be a battery cover that can be separated from the terminal body 15 when the battery is replaced. However, the cover 11 is not limited thereto, and may also be an integral cover that is difficult to separate from the terminal body 15.

The battery 12 may be a secondary battery that can be repeatedly charged and discharged, and may be attached to and detached from the portable terminal 10, but is not limited thereto.

The antenna module 100 is disposed between the terminal body 15 and the cover 11, and charges the battery 12 by receiving power transmitted from the wireless charging device 20 and supplying the received power to the battery 12. The antenna module 100 may be directly attached to an inner surface of the cover 11, or may be disposed as close as possible to the inner surface of the cover 11.

The charging device 20 is provided to charge the battery 12 of the portable device 10. To this end, the charging device 20 includes a voltage converting part 22 and a power transmitter 200 in a case 21.

The voltage converting part 22 converts household alternating current (AC) power supplied from an external power source into direct current (DC) power, and then converts the DC power into an AC voltage having a particular frequency and supplies the AC voltage having the particular frequency to the power transmitter 200.

When the AC voltage is applied to the power transmitter 200, a magnetic field around the power transmitter 200 changes as the AC voltage changes. As a result, a voltage is induced in a wiring portion 110 of the portable terminal 10 disposed adjacent to the power transmitter 200 according to the change in the magnetic field, and this voltage charges the battery 12.

The power transmitter 200 may be configured in a manner similar to the antenna module 100 described above. Therefore, a detailed description of the power transmitter 200 will be omitted.

Hereinafter, the antenna module 100 will be described in detail.

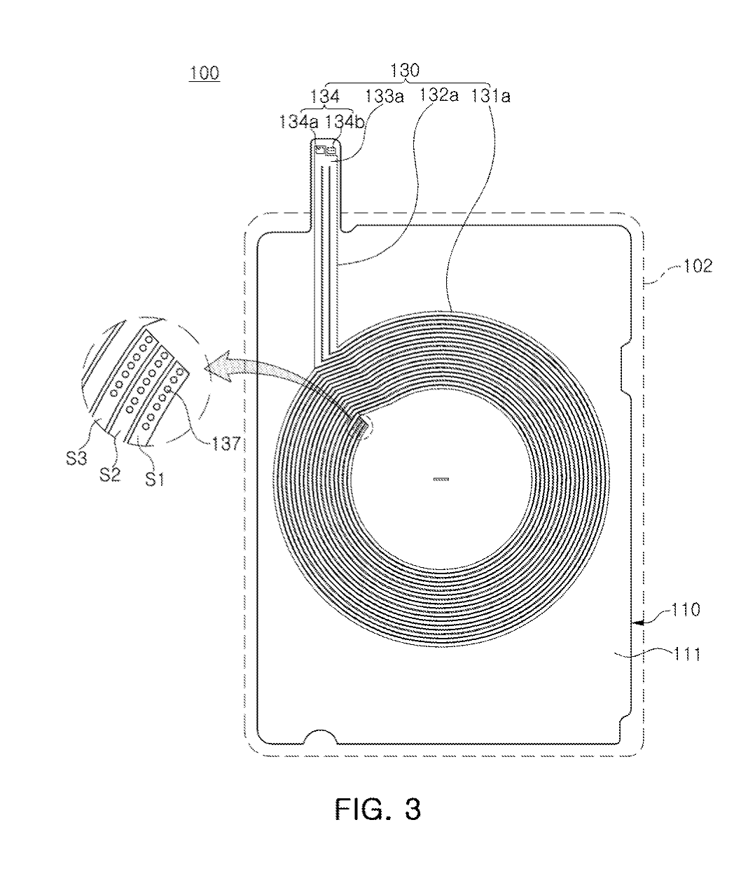

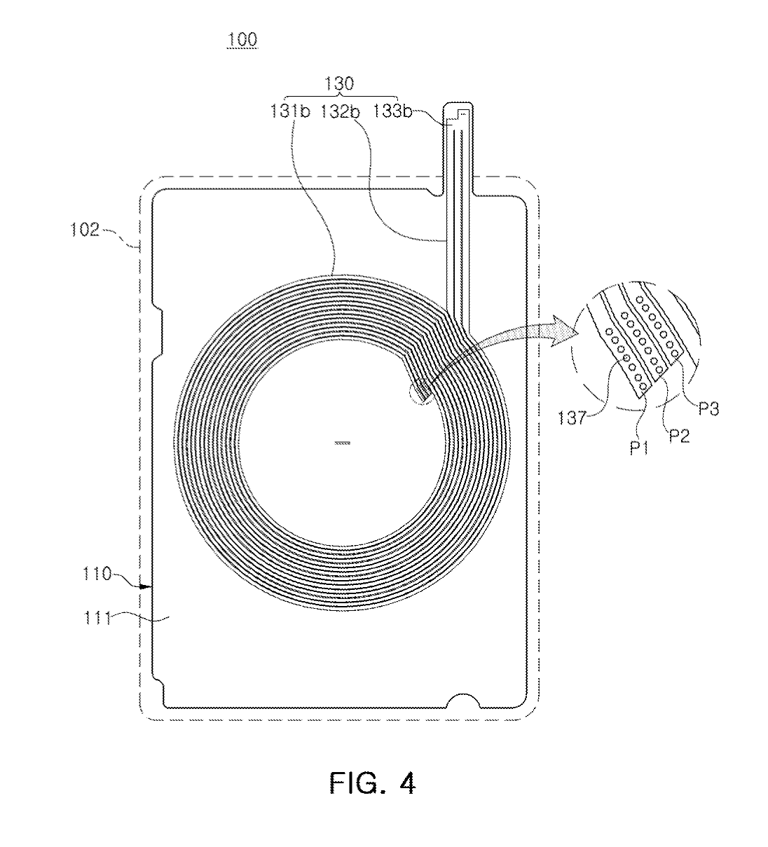

FIG. 3 is a plan view schematically illustrating a first surface of an example of an antenna module, and FIG. 4 is a plan view schematically illustrating a second surface of the antenna module illustrated in FIG. 3.

Referring to FIGS. 3 and 4, the antenna module 100 includes a wiring portion 110 and a magnetic portion 102. The wiring portion 110 includes an insulating substrate 11 and communications wiring 130. The communications wiring 130 includes spiral wirings 131a and 131b having a coil shape, lead wirings 132a and 132b, connecting parts 133a and 133b, and connection pads 134. The connection pads 134 include a first connection pad 134a and a second connection pad 134b.

The magnetic portion 102 has a flat plate shape (or a sheet shape), and is disposed on one surface of the wiring portion 110 and coupled to the wiring portion 110. The magnetic portion 102 is provided to efficiently form a magnetic path for a magnetic field generated by the communications wiring 130 of the wiring portion 110. To this end, the magnetic portion 102 is formed of a material capable of easily forming the magnetic path, such as a ferrite sheet, but is not limited thereto.

Although not illustrated, a metal sheet may also be added between the magnetic portion 102 and the battery 12 to shield the battery 12 from electromagnetic waves or leakage magnetic flux as needed. The metal sheet may be formed of aluminum, for example, but a material of the metal sheet is not limited thereto.

In addition, the antenna module 100 has the adhesive part 104 interposed between the wiring portion 110 and the magnetic portion 102 so that the wiring portion 110 and the magnetic portion 102 are firmly fixed and bonded to each other.

The adhesive part 104 is disposed between the wiring portion 110 and the magnetic portion 102 and bonds the magnetic portion 102 and the wiring portion 110 to each other. The adhesive part 104 may be formed of an adhesive sheet or an adhesive tape, or may be formed by coating a surface of the wiring portion 110 or the magnetic portion 102 with an adhesive or a resin having adhesive properties.

In addition, the adhesive part 104 may contain ferrite powder particles, causing the adhesive part 104 to have magnetic properties similar to the magnetic portion 102.

The magnetic portion 102 is disposed to face the spiral wirings 131a and 131b. In addition, the magnetic portion 102 is disposed to face portions of the lead wirings 132a and 132b adjacent to the spiral wirings 131a and 131b, but is disposed not to face the connecting parts 133a and 133b.

The wiring portion 110 has a form of a substrate. In more detail, the wiring portion 110 includes the insulating substrate 111 and the communications wiring 130 formed on opposite surfaces of the insulating substrate 111.

The insulating substrate 111 is a substrate on which circuit wiring may be formed on one surface or opposite surfaces thereof, and may be, for example, an insulating film (e.g., a polyimide film). In this example, the wiring portion 110 has a form of a flexible printed circuit board (PCB). However, the insulating substrate 111 is not limited thereto, and various kinds of substrates (e.g., a printed circuit board, a ceramic substrate, a glass substrate, an epoxy substrate, and a flexible substrate) may be selectively used as long as the circuit wiring may be formed on one surface or opposite surfaces thereof.

In the example illustrated in FIGS. 3 and 4, the communications wiring 130 is formed on the opposite surfaces of the insulating substrate 111.

The communications wiring 130 is formed on the opposite surfaces of the insulating substrate 111 and have, for example, a form of a circuit wiring formed of a copper foil, but is not limited thereto.

The communications wiring 130 may be manufactured by patterning a double-sided copper-clad laminate (CCL). Alternatively, the communications wiring 130 may be formed on the opposite surfaces of a flexible insulating substrate such as a film by a photolithography method, and may be manufactured, for example, using a flexible PCB (FPCB) having a double-sided structure.

Accordingly, the wiring portion 110 has a very small thickness. However, the wiring portion 110 may also be manufactured as a multilayer substrate, or in a form of a printed circuit board (PCB) having rigidity, as needed.

The communications wiring 130 is formed of a metal layer of a thin film, and includes the spiral wirings 131a and 131b having a coil shape, the lead wirings 132a and 132b, the connecting parts 133a and 133b, and the connection pad 134.

The connection pad 134 is a contact point that can be electrically connected to other components. Therefore, the connection pad 134 is connected to both end portions of the spiral wirings 131a and 131b through the lead wirings 132a and 132b, and is exposed to the outside of the antenna module 100 so that it may be physically connected to an external component.

The spiral wirings 131a and 131b are disposed on the opposite surfaces of the insulating substrate 111 to face each other. Accordingly, the spiral wirings 131a and 131b are a first spiral wiring 131a formed on a first surface of the insulating substrate 111 and a second spiral wiring 131b formed on a second surface of the insulating substrate 111. In addition, an overall width (or an outer diameter) of the first spiral wiring 131a is equal to an overall width (or an outer diameter) of the second spiral wiring 131b.

In this example, the first spiral wiring 131a and the second spiral wiring 131b have spirals formed in the same direction. That is, as illustrated in FIGS. 3 and 4, the first spiral wiring 131a and the second spiral wiring 131b have spirals formed in the same direction (e.g., a clockwise direction in the example illustrated in FIGS. 3 and 4).

When a current flows in the wiring portion 110, the current flows in the same direction in the first spiral wiring 131a and the second spiral wiring 131b when the first spiral wiring 131a and the second spiral wiring 131b are viewed from the same side of the wiring portion 110. This is because the current in the wiring portion 110 flows from the outermost turn to the innermost turn of the first spiral wiring 131a, and then flows from the innermost turn to the outermost turn of the second spiral wiring 131b, or vice versa. This causes a magnetic field generated by the current flowing in the first spiral wiring 131a and a magnetic field generated by the current flowing in the second spiral wiring 131b to reinforce each other, a power reception efficiency is improved.

The first spiral wiring 131a and the second spiral wiring 131b are connected to each other by interlayer connection conductors 137 at inner end portions of the first spiral wiring 131a and the second spiral wiring 131b.

The interlayer connection conductors 137 are disposed in the insulating substrate 111 so that they penetrate through the insulating substrate 111 and electrically connect the first spiral wiring 131a and the second spiral wiring 131b to each other.

In the example illustrated in FIGS. 3 and 4, a plurality of interlayer connection conductors 137 are disposed in a line. However, the interlayer connection conductors are not limited thereto, but may be disposed in other arrangements as long as they connect the first spiral wiring 131a and the second spiral wiring 131b to each other.

The interlayer connection conductors 137 may be formed by forming through holes in the insulating substrate 111 and then filling the through holes with a conductive material, but are not limited thereto.

The lead wirings 132a and 132b are wirings that connect outer end portions of the spiral wirings 131a and 131b to the connection pad 134. Therefore, the lead wirings 132a and 132b include a first lead wiring 132a disposed on the first surface of the insulating substrate 111 and connecting the outer end portion of the first spiral wiring 131a to the first connection pad 134a, and a second lead wiring 132b disposed on the second surface of the insulating substrate 111 and connecting the outer end portion of the second spiral wiring 131a to the second connection pad 134b.

The first spiral wiring 131a and the second spiral wiring 131b are connected to each other through the interlayer connection conductors 137 at the inner end portions of the first spiral wiring 131a and the second spiral wiring 131b. Therefore, the lead wirings 132a and 132b extend from the outer end portions of the first spiral wiring 131a and the second spiral wiring 131b to the first connection pad 134a and the second connection pad 134b.

Accordingly, the communications wiring 130 includes the first connection pad 134a, the first lead wiring 132a, the first spiral wiring 131a, the interlayer connection conductors 137, the second spiral wiring 131b, the second lead wiring 132b, and the second connection pad 134 connected to each other in series in the order listed to form one coil wiring.

Although not illustrated, an protective insulating layer may be formed on the communications wiring 130. The protective insulating layer may be provided to protect the communications wiring 130 from damage and insulate the communications wiring 130 from contacting external elements. The connection pad 134 is provided to contact an external component and be electrically connected to the external component. Therefore, the protective insulating layer disposed on the communications wiring 130 is not disposed on the connection pad 134, or is removed from the connection pad 134 if it is disposed on the connection pad 134, so that the connection pad 134 is exposed so that it can be electrically connected to the external component.

In the example illustrated in FIGS. 3 and 4, the communications wiring 130 protrudes from the insulating substrate 111. However, the communications wiring 130 is not limited thereto, but may be modified in various ways. For example, at least a portion of the communications wiring 130 may be embedded in the insulating substrate 111.

The overall contour of the first spiral wiring 131a and the second spiral wiring 131b is an annular shape (or a ring shape). Therefore, a region (hereinafter, referred to as a central region) in which the communications wiring 130 is not formed is formed in the centers of the first spiral wiring 131a and the second spiral wiring 131b. Hereinafter, the central region refers to an inner region of the spiral wiring in which the communications wiring 130 is not formed.

When a current flows in a conductor, the current does not flow through the entire cross-sectional area of the conductor, but rather flows through an outer portion of the cross-sectional area due to the ‘skin effect.’ The skin effect is a phenomenon in which the current flows only near the surface of the conductor such as a metal when a high frequency current is applied to the conductor. The skin effect is caused by a counter-electromotive force generated inside the conductor due to a rapid change of the current flowing through the conductor, thereby making it difficult for the current to flow in the central portion of the conductor. The higher the frequency of the current, the closer the current flows to the surface of the conductor.

In addition, the current flowing in the conductor is affected by a proximity effect, which is a phenomenon in which the current does not evenly flow in the conductor, but is biased to one side of the conductor, due to eddy currents induced in the conductor by a current flowing in an adjacent conductor.

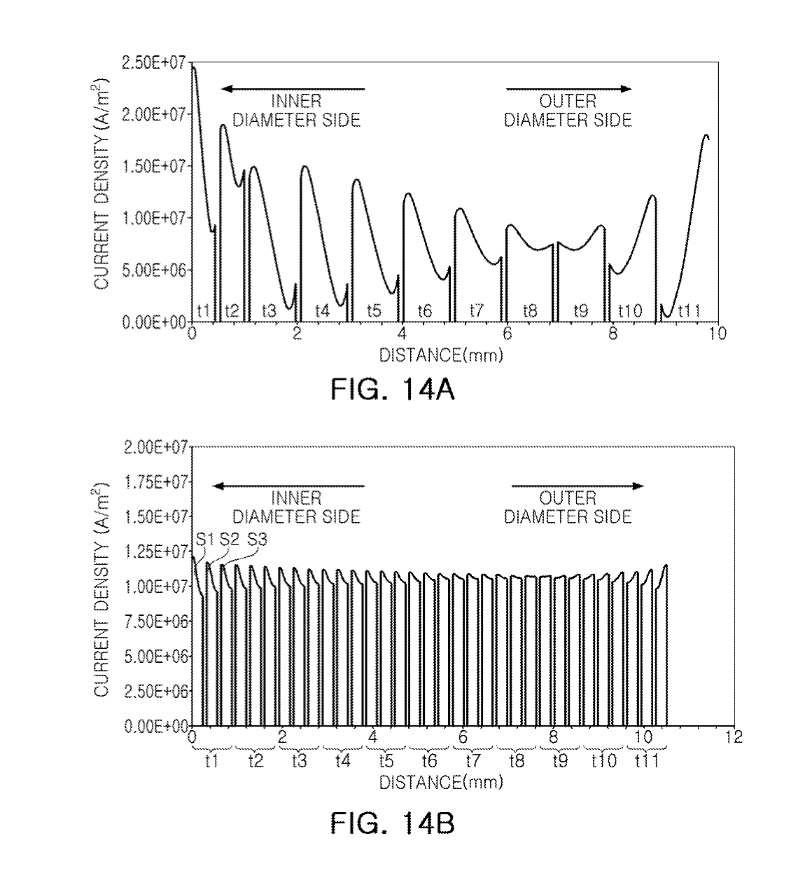

FIG. 14A and FIG. 14B are graphs illustrating examples of simulations of current density in a spiral wiring. FIG. 14A illustrates an example of a simulation of current density in a single wiring, that is, a wiring in which each turn is formed by a single conductor, and FIG. 14B illustrates an example of a simulation of current density in a divided wiring, that is, a wiring in which each turn is formed by a plurality of conductors or coil strands.

In FIGS. 14A and 14B, the X axis indicates a radial distance measured from an inner diameter of the spiral wiring. Therefore, as X increases, a position in the spiral wiring moves from the inner diameter of the spiral wiring to an outer diameter side of the spiral wiring. The Y axis indicates a current density in the spiral wiring.

Referring to FIG. 14A, it may be seen that the current density in each of turns t1 to t11 is not constant and is mostly biased to one side. As can be seen from FIG. 14A, the current density in turns t1 to t8 is biased toward an inner side of the single conductor forming each turn, and the current density in turns t9 to t11 is biased toward an outer side of single conductor.

Thus, in a spiral wiring in which each turn is formed by a single conductor, the current flowing in each turn does not evenly flow along a surface of the conductor, but is biased to one side of the conductor.

Since the current does not flow evenly along the surface of the conductor, an amount of current that can flow in the conductor is limited and a resistance value of the conductor is increased, thereby reducing power reception efficiency.

Therefore, in the examples disclosed in this application, to prevent the power reception efficiency from being reduced due to the above-mentioned factors, each of the turns t1 to t11 of the communications wiring 130 is divided into a plurality of coil strands S1, S2, and S3 as illustrated in FIG. 14B. As a result, the communications wiring 130 in the examples disclosed in this application are structurally formed in a form of a Litz wire.

As can be seen from FIG. 14B, the current density is almost uniform in each coil strand when compared to FIG. 14A.

As described above, if one wiring is divided into a plurality of coil strands, the skin effect and the bias phenomenon of the current produced by the proximity effect are mitigated. However, as the number of divided coil strands increases, an interval between the coil strands also increases. As a result, a DC resistance also increases. Therefore, when the wiring is divided into an excessively large number of coil strands, the power reception efficiency may be reduced.

Therefore, in the example illustrated in FIGS. 3 and 4, the communications wiring 130 includes three coil strands S1, S2, and S3. However, the communications wiring 130 is not limited thereto, but may include two coil strands or four or more coil strands.

For convenience of explanation, in the drawings, the three coil strands of the first spiral wiring 131a are denoted by S1, S2, and S3, and the three coil strands of the second spiral wiring 131b are denoted by P1, P2, and P3. However, the coil strands S1, S2, and S3 of the first spiral wiring 131a are respectively connected to the coil strands P1, P2, and P3 of the second spiral wiring 131b, so the phrase ‘coil strands S1, S2, and S3’ refers to all of the coil strands S1, S2, and S3 of the first spiral wiring 131a and the coil strands P1, P2, and P3 of the second spiral wiring 131b connected thereto, unless the coil strands are separately distinguished in the following description.

The coil strands S1, S2, and S3 are spaced apart from each other by a same interval, and all have a same line width.

The three coil strands S1, S2, and S3 are electrically connected to each other at one end of each of the lead wirings 132a and 132b connected to the connection pad 134. Therefore, the first lead wiring 132a and the second lead wiring 132b include the connecting parts 133a and 133b at which the plurality of coil strands are electrically connected to each other.

The coil strands S1, S2, and S3 are connected in parallel by the connecting parts 133a and 133b.

In the example illustrated in FIGS. 3 and 4, the connecting parts 133a and 133b are disposed positions where the lead wirings 132a and 132b and the connection pad 134 are connected to each other. However, the connecting parts 133a and 133b are not limited thereto, but may be disposed at various positions of the lead wirings 132a and 132b as long as the positions do not face the magnetic portion 102.

If the connecting parts 133a and 133b are disposed at positions facing the magnetic portion 102, or are disposed within the spiral wirings 131a and 131b, the advantageous effects obtained by dividing the communications wiring 130 into the plurality of coil strands S1, S2, and S3 are reduced.

Therefore, in the examples of the antenna module 100 disclosed in this application, the connecting parts 133a and 133b are disposed only outside the spiral wirings 131a and 131b, that is, on the lead wirings 132a and 132b. In addition, the connecting parts 133a and 133b are disposed only at positions of the lead wirings 132a and 132b that do not face the magnetic portion 102. Therefore, the plurality of coil strands S1, S2, and S3 are not electrically connected to each other inside at positions within the spiral wirings 131a and 131b, or at positions facing the magnetic portion 102.

In another example in which the coil strands S1, S2, and S3 are directly connected to the connection pad 134, the coil strands S1, S2, and S3 are electrically connected to each other by the connection pad 134. In this case, the connecting parts 133a and 133b are omitted.

The antenna module 100 described above provides the communications wiring 130 divided into the plurality of coil strands. As described above, when the communications wiring 130 is formed of the plurality of coil strands S1, S2, and S3, rather than one wiring, the size of the region in the conductor in which the current does not flow is reduced, and the phenomenon in which the current density is biased to one side of the wiring is reduced.

In addition, the divided coil strands S1, S2, and S3 are not electrically connected to each other at positions within the spiral wirings 131a and 131b but are electrically connected to each other at positions in the lead wirings 132a and 132b extending from the spiral wirings 131a and 131b.

Therefore, when the antenna module 100 described above is used for wireless charging, charging efficiency is increased compared to wireless charging using a conventional antenna module.

The antenna module 100 is not limited to the above-mentioned examples, but may be modified in various ways.

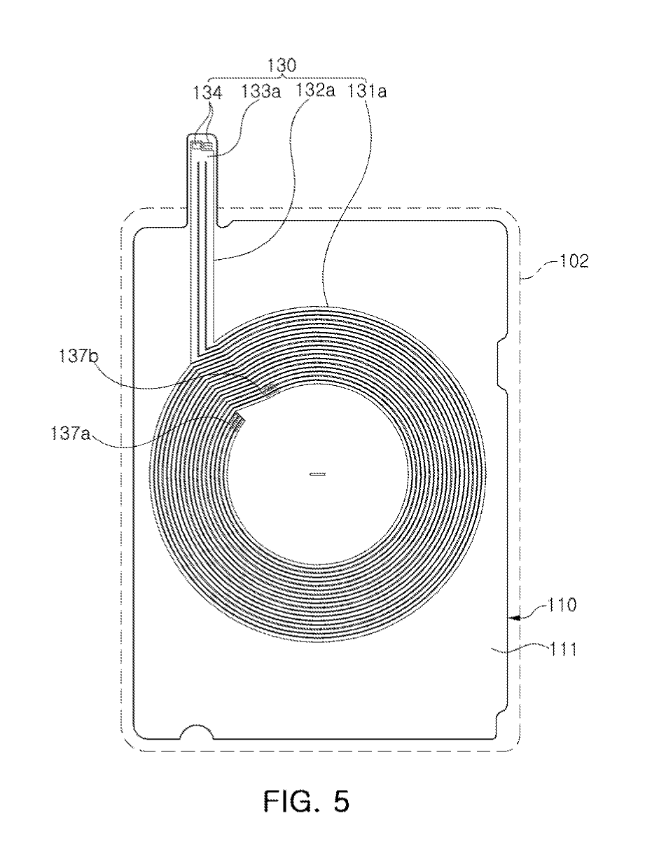

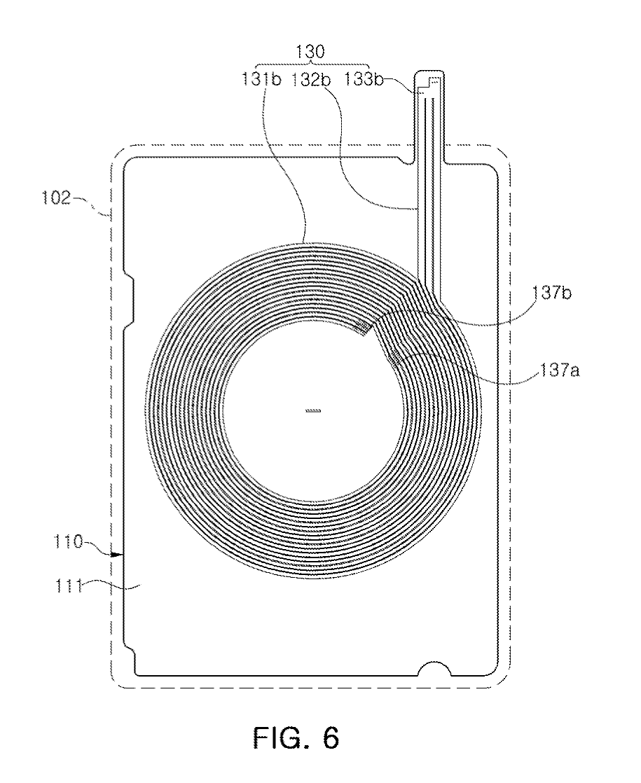

FIG. 5 is a plan view schematically illustrating a first surface of another example of an antenna module, and FIG. 6 is a plan view schematically illustrating a second surface of the antenna module illustrated in FIG. 5.

Referring to FIGS. 5 and 6, in the antenna module of this example, some turns of the spiral wirings 131a and 131b are connected to each other in parallel.

In this example, one turn (hereinafter referred to as the innermost turn) disposed at the inner diameter of each of the spiral wrings 131a and 131b are connected to each other in parallel. To this end, the antenna! module of this example includes a first interlayer connection conductor 137a and a second interlayer connection conductor 137b.

The first interlayer connection conductor 137a connects an inner end portion of the first spiral wiring 131a with a point at which the innermost turn of the second spiral wiring 131b starts in the second spiral wiring 131b. In addition, the second interlayer connection conductor 137b connects an inner end portion of the second spiral wiring 131b with a point at which the innermost turn of the first spiral wiring 131a starts in the first spiral wiring 131a.

By the configuration described above, the innermost turn of the first spiral wiring 131a and the innermost turn of the second spiral wiring 131b are connected to each other in parallel. Therefore, the first spiral wiring 131a and the second spiral wiring 131b are connected to each other in a series structure through a parallel structure in which the innermost turn of the first spiral wiring 131a and the innermost turn of the second spiral wiring 131b are connected to each other in parallel.

Since magnetic flux density is generally concentrated in the central region of the spiral coil, the current bias phenomenon due to a proximity effect is greatest in the wiring (e.g., the innermost turn) adjacent to the central region.

Therefore, in this example, additional electrical paths are provided by connecting the innermost of the first spiral wiring 131a and the innermost turn of the second spiral wiring 131b to each other in parallel. As result, since the current is dispersed and flows into the six coil strands of the innermost turns, the current density in each coil strand is decreased. As a result, the current bias phenomenon is also significantly reduced, thereby increasing power transmission efficiency.

Since the innermost turns of the communications wiring 130 are connected in parallel with each other, the innermost turns of the communications wiring 130 include twice as many coil strands (e.g., six coil strands) as the other turns. Therefore, although not illustrated, a line width of the innermost turns may be narrower than a line width of the other turns. For example, the line width of the innermost turns may be decreased to half of line width of the other turns. In this case, the phenomenon in which the current is biased to one side of the conductor is further reduced, and inner diameters of the spiral wirings 131a and 131b may be increased.

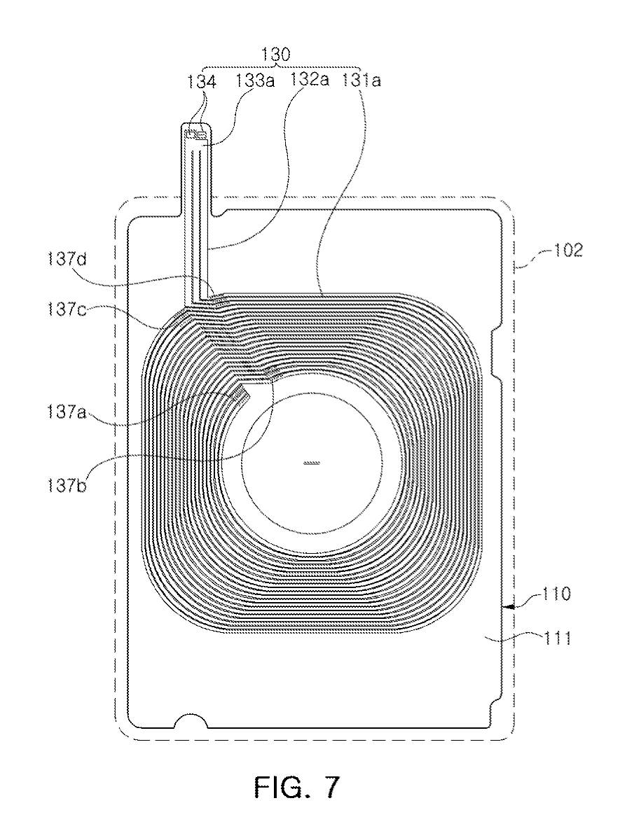

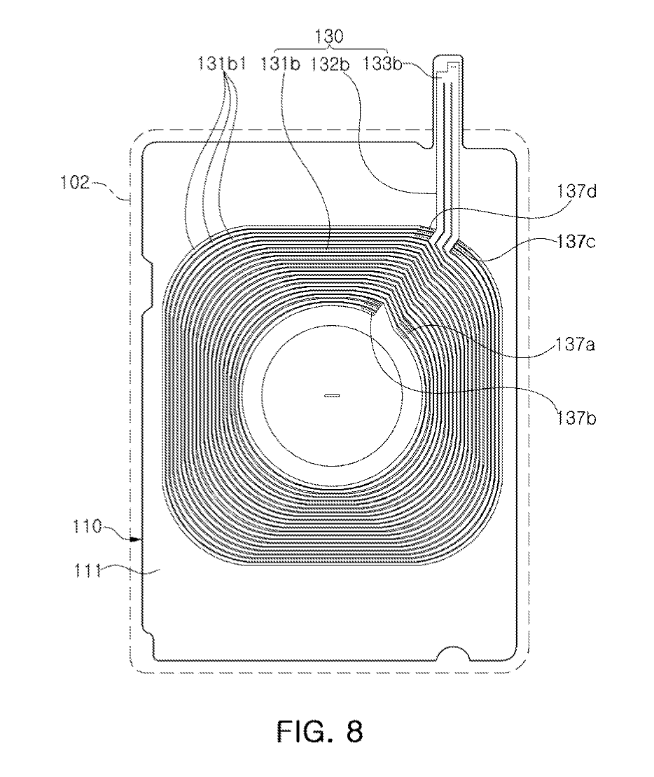

FIG. 7 is a plan view schematically illustrating a first surface of another example of an antenna module, and FIG. 8 is a plan view schematically illustrating a second surface of the antenna module illustrated in FIG. 7.

Referring to FIGS. 7 and 8, the antenna module of this example is configured in a manner similar to the antenna module illustrated in FIGS. 5 and 6, except that one turn (hereinafter referred to as the outermost turn) disposed at the outer diameter of each of the spiral wirings 131a and 131b are also connected to each other in parallel.

In general, in a spiral coil, the current bias phenomenon due to the proximity effect is greatest at the innermost turn as discussed above in connection with FIGS. 5 and 6, and is next greatest at the outermost turn.

Therefore, in this example, additional electrical paths are provided by also connecting the outermost turns to each other in parallel. As a result, similar to the result obtained by connecting the innermost turns in parallel, since the current is dispersed and flows into six coil strands in the outermost turns, the current density in each coil strand in the outermost turns is decreased.

To connect the outermost turns in parallel, both ends of the outermost turn of the first spiral wiring 131a are connected to both ends of the outermost turn of the second spiral wiring 131b by a third interlayer connection conductor 137c and a fourth interlayer connection conductor 137d, thereby connecting the outermost turns in parallel.

To this end, the second spiral wiring 131b separately includes an expansion wiring 131b1 for forming the outermost turn of the second spiral wiring 131b that is connected in parallel with the outermost turn of the first spiral wiring 131a. The expansion wiring 131b1 is not directly connected to the rest of the second spiral wiring 131b, but is used only to form a parallel connection with the outermost turn of the first spiral wiring 131a.

As described above, in the case in which the outermost turns of the spiral wirings 131a and 131b are connected in parallel, since the number of the coil strands S1, S2, and S3 is increased in the outermost turns, the concentration of the current density in a specific region of the outermost turns is reduced.

Since the outermost turns are connected in parallel, the outermost turns include twice as many coil strands (e.g., six coil strands) as the other turns excluding the innermost turns. Therefore, although not illustrated, the line width of the outermost turns may be narrower than a line width of the other turns excluding the innermost turns. For example, the line width of the outermost turns may be decreased to half the line width of the other turns excluding the innermost turns. In this case, the phenomenon in which the current is biased to one side of the conductor is further reduced, and inner diameters of the spiral wirings 131a and 131b may be increased.

In addition, in the example of the antenna module illustrated in FIGS. 7 and 8, outer peripheries of the spiral wirings 131a and 131b have a quadrangular shape and inner peripheries thereof have a circular shape. In this example, the line width is increased in corner portions of the spiral wirings 131a and 131b to form the quadrangular shape. However, the configuration of the spiral wirings 131a and 131b is not limited thereto, and the shapes of one or both of the outer periphery and the inner periphery may be modified in various ways. For example, the outer periphery and the inner periphery may both have the quadrangular shape or may have an oval shape or another polygonal shape.

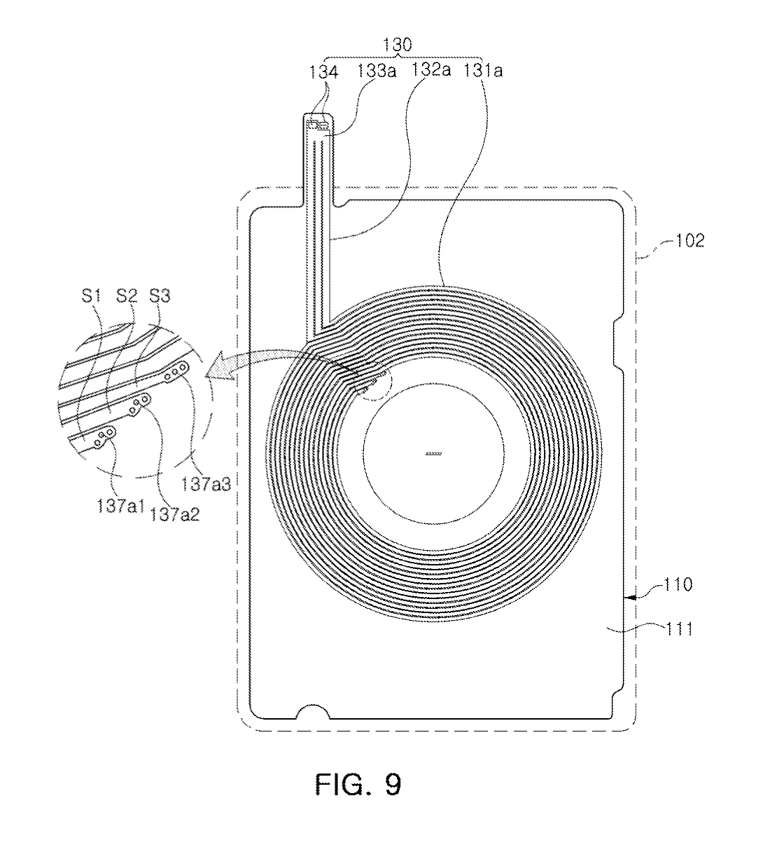

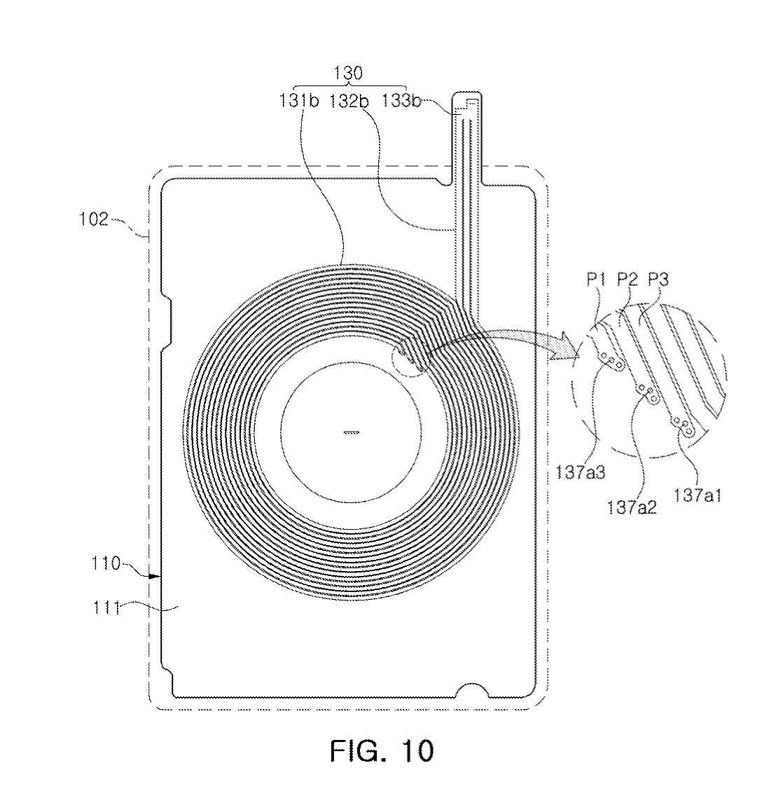

FIG. 9 is a plan view schematically illustrating a first surface of another example of an antenna module, and FIG. 10 is a plan view schematically illustrating a second surface of the antenna module illustrated in FIG. 9.

Referring to FIGS. 9 and 10, in this example, the order in which the coil strands S1, S2, and S3 are disposed is changed when moving from the first spiral wiring 131a to the second spiral wiring 131b. This will be described in more detail as follows.

As in the examples described above, each turn of the spiral wirings 131a and 131b includes the plurality of coil strands S1, S2, and S3. In this example, as illustrated in FIG. 9, each turn of the first spiral wiring 131a includes a first coil strand S1 disposed at the innermost side of the turn, a third coil strand S3 disposed at the outermost side of the turn, and a second coil strand S2 disposed between the first coil strand S1 and the third coil strand S3.

In this example, the first coil strand S1 is always disposed at the innermost side of each turn of the first spiral wiring 131a. In addition, the third coil strand S3 is always disposed at the outermost side of each turn of the first spiral wiring 131a. Therefore, in a case in which the first coil strand S1 of the first spiral wiring 131a is connected to the first coil strand P1 of the second spiral wiring 131b and the third coil strand S3 of the first spiral wiring 131a is connected to the third coil strand P3 of the second spiral wiring 131b, total lengths of the coil strands S1, S2, and S3 are different from each other. As a result, an impedance is concentrated on a specific coil strand.

Therefore, in order to solve the above-mentioned problem, in the communications wiring 130 of this example, the coil strands S1, S2, and S3 included in the first spiral wiring 131a and the coil strands P1, P2, and P3 included in the second spiral wiring 131b are connected to each other in opposite order in a diameter direction, thereby making the total lengths of the coil strands equal to each other.

Specifically, the first coil strand S1 disposed at the innermost side of each turn of the first spiral wiring 131a is connected to the third coil strand P3 disposed at the outermost side of each turn of the second spiral wiring 131b through an interlayer connection conductor 137a1, and the third coil strand S3 disposed at the outermost side of each turn of the first spiral wiring 131a is connected to the first coil strand P1 disposed at the innermost side of each turn of the second spiral wiring 131b through an interlayer connection conductor 137a3.

In addition, the second coil strand S2 of the first spiral wiring 131a is connected to the second coil strand P2 of the second spiral wiring 131b through an interlayer connection conductor 137a2.

By configuring the communications wiring 130 as described above, since an average of distances from the centers of the spiral wirings 131a and 131b to the coil strands S1, S2, and S3 is approximately uniform, the concentration of the impedance on the specific coil strand is reduced or eliminated.

In a case in which a total number of turns of the spiral wirings 131a and 131b is an even number (e.g., ten turns), since five turns are disposed on each of the opposite surfaces of the insulating substrate 111, the innermost turn may be configured as in this example.

On the other hand, in a case in which the total number of turns of the spiral wirings 131a and 131b is an odd number (e.g., eleven turns), since 5.5 turns need to be disposed on each of the opposite surfaces of the insulating substrate 111, the example of FIGS. 9 and 10 is modified in another example to be described below.

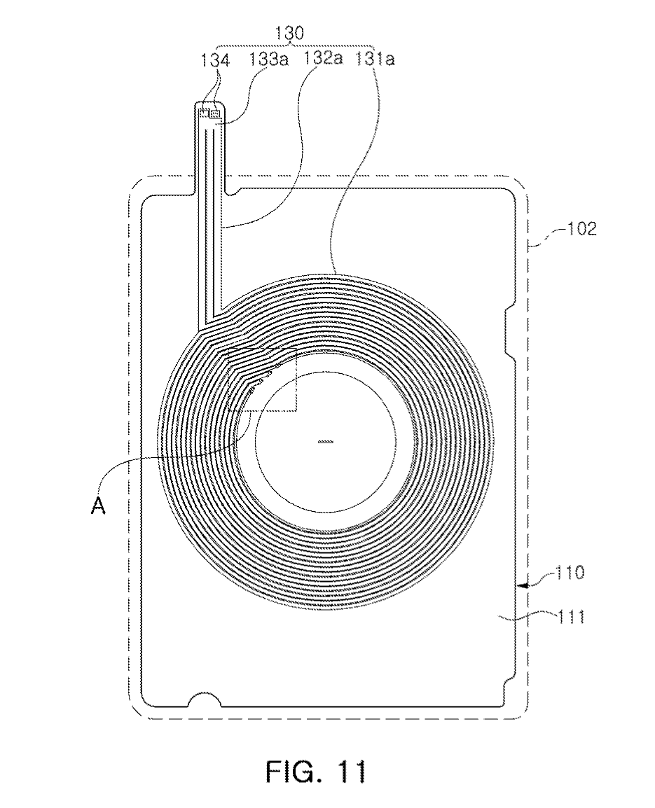

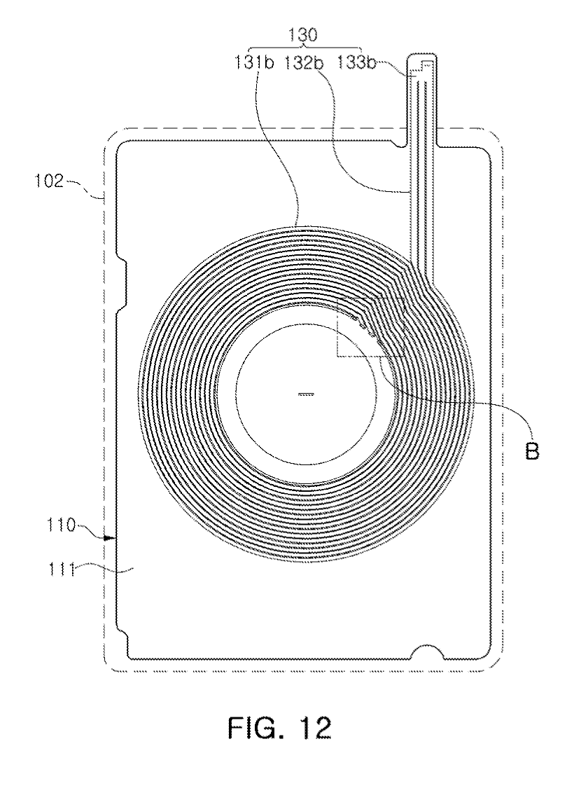

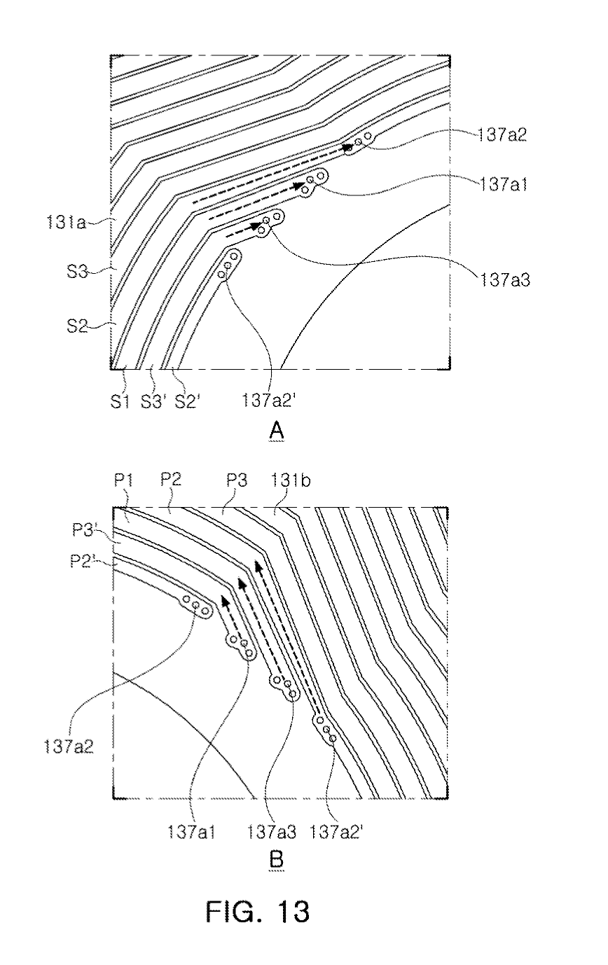

FIG. 11 is a plan view schematically illustrating a first surface of another example of an antenna module, FIG. 12 is a plan view schematically illustrating a second surface of the antenna module illustrated in FIG. 11, and FIG. 13 is an enlarged view of portions A and B of FIGS. 11 and 12.

Referring to FIGS. 11 through 13, the antenna module of this example is formed in a way similar to the antenna module of the example of FIGS. 9 and 10, and differs only in a structure of the innermost turn.

The communications wiring 130 of the example illustrated in FIGS. 11 through 13 has an odd number of turns (e.g., eleven turns). Accordingly, to dispose the spiral wirings 131a and 131b equally on the opposite surfaces of the insulating substrate 111, coil strands of one turn (the innermost turn) are dispersed on the opposite surfaces of the insulating substrate 111.

More specifically, the innermost turn of the first spiral wiring 131a does not include the first coil strand S1, but includes only a second coil strand S2′ and a third coil strand S3′. In addition, the innermost turn of the second spiral wiring 131b does not include the first coil strand P1, but includes only a second coil strand P2′ and a third coil strand P3′.

The first coil strand S1 of the second innermost turn of the first spiral wiring 131a is connected to the third coil strand P3′ of the innermost turn of the second spiral wiring 131b through an interlayer connection conductor 137a1. Therefore, the third coil strand P3′ of the innermost turn of the second spiral wiring 131b serves as the first coil strand of the innermost turn of the spiral wiring formed by the first spiral wiring 131a and the second spiral wiring 131b.

In addition, the third coil strand S3′ of the innermost turn of the first spiral wiring 131a is connected to the first coil strand P1 of the second innermost turn of the second spiral wiring 131b through an interlayer connection conductor 137a3. Therefore, the third coil strand S3′ of the innermost turn of the first spiral wiring 131a serves as the third coil strand of the innermost turn of the spiral wiring formed by the first spiral wiring 131a and the second spiral wiring 131b.

In addition, the second coil strand S2′ of the innermost turn of the first spiral wiring 131a is connected to the second coil strand P2 of the second innermost turn of the second spiral wiring 131b through an interlayer connection 137a2′, and the second coil strand S2 of the second innermost turn of the first spiral wiring 131a is connected to the second coil strand P2′ of the innermost turn of the second spiral wiring 131b through an interlayer connection conductor 137a2.

In detail, the first coil strand of the innermost turns is formed as the third coil strand P3′ of the second spiral wiring 131b on the second surface of the insulating substrate 111. In addition, the third coil strand S3′ of the first spiral wiring 131a is disposed on the first surface of the insulating substrate 111. In addition, the second coil strands S2′ and P2′ of the innermost turns on the opposite surfaces of the insulating substrate 111 are connected to each other in parallel.

To this end, the interlayer connection conductors 137a2 and 137a2′ are respectively disposed at a start point and an end point of the second coil strands S2′ and P2′ of the innermost turn, and the second coil strands S2′ and P2′ disposed on the opposite surfaces of the insulating substrate 111 are connected to each other in parallel. Since the parallel connection of the second coil strands S2′ and P2′ is similar to the parallel connection of the innermost turns in the example of FIGS. 5 and 6 described above and the parallel connection of the innermost turns and the parallel connection of the outermost turns in the example of FIGS. 7 and 8 described above, a detailed description thereof will be omitted.

In the example illustrated in FIGS. 11 through 13, line widths of the second coil strands S2′ and P2′ are narrower than line widths of the third coil strands S3′ and P3′. For example, the line width of the second coil strands S2′ and P2′ is half of the line widths of the third coil strands S3′ and P3′. However, the line width of the second coil strands S2′ and P2′ is not limited thereto.

In the example of the antenna module described above, even though the total number of the turns of the spiral wiring is an odd number, the antenna wirings are evenly dispersed on the first surface and the second surface of the insulating substrate.

In the example of FIGS. 11 through 13 described above, the communications wiring 130 includes the three coil strands S1, S2, and S3, and as a result, the second coil strands of the innermost turn are connected in parallel. However, in a case in which the number of coil strands is an even number (e.g., four coil strands), half (e.g., the first coil strand and the second coil strand) of the coil strands of the innermost turn may be included in the first spiral wiring 131a, and the remaining half (e.g., the third coil strand and the fourth coil strand) may be included in the second spiral wiring 131b.

Although the insulating substrate 111 in the examples described above includes only one communications wiring 130 that performs wireless charging, the insulating substrate 111 is not limited thereto, but may include a plurality of communications wirings 130. For example, the insulating substrate 111 may include one or more communication wirings 130 that perform any one or any combination of any two or more of radio frequency identification (RFID), near-field communication (NFC), and magnetic secure transmission (MST) in addition to or in place of wireless charging.

Further, features of the examples described above may be combined with each other. For example, the parallel connection of the outermost turns of the antenna module illustrated in FIGS. 7 and 8 may be applied to the outermost turns of the antenna module illustrated in FIGS. 9 and 10 or FIGS. 11 and 12.

Further, although the example of FIGS. 5 and 6 described above illustrates a case in which only the innermost one turns are connected to each other in parallel, and the example of

FIGS. 7 and 8 described above illustrates a case in which the innermost one turns are connected to each other in parallel and the outermost one turns are connected in parallel with each other, the turns that are connected in parallel with each other may be modified in various ways. For example, two or more turns, for example, the innermost two turns, may be connected in parallel with each other.

In the examples described above, since the communications wiring of the antenna module is formed with a plurality of coil strands for each turn of the spiral wiring, rather than with a single conductor for each turn of the spiral wiring, the region inside the coil strands in which the current does not flow is reduced, and an increase in a resistance of the spiral wiring due to the current flowing in the spiral wiring being biased to one side of the coil strands is suppressed.

In addition, the divided coil strands are not electrically connected to each other within the spiral wiring, but are electrically connected to each other in a lead wiring that extends away from the spiral wiring. Therefore, when the examples of the antenna module described above are used for wireless charging, the charging efficiency is increased compared to wireless charging performed using a conventional antenna module.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure. what is claimed is:

1. An antenna module comprising:
an insulating substrate; and
communications wiring disposed on opposite surfaces of the insulating substrate and comprising a spiral wiring formed by a first spiral wiring disposed on a first surface of the insulating substrate and a second spiral wiring disposed on a second surface of the insulating substrate,
wherein the spiral wiring comprises a plurality of coil strands spaced apart from each other and not electrically connected to each other within the spiral wiring, and
the communications wiring further comprises a connecting part electrically connecting the plurality of coil strands to each other outside the spiral wiring.

2. The antenna module of claim 1, wherein the communications wiring further comprises:
a connection pad; and
a lead wiring connecting an outer end portion of the spiral wiring to the connection pad, and
the connecting part is disposed within the lead wiring.

3. The antenna module of claim 1, wherein the coil strands of the first spiral wiring and the coil strands of the second spiral wiring are respectively connected to each other through interlayer connection conductors disposed in the insulating substrate.

4. The antenna module of claim 3, wherein the coil strands of the first spiral wiring and the coil strands of the second spiral wiring are connected to each other in opposite order in a diameter direction of the spiral wiring.

5. The antenna module of claim 4, wherein a coil strand disposed in an innermost position in each turn of the first spiral wiring among the coil strands of the first spiral wiring is connected to a coil strand disposed in an outermost position of each turn of the second spiral wiring among the coil strands of the second spiral wiring.

6. The antenna module of claim 4, wherein the coil strands of an innermost turn of the first spiral wiring and an innermost turn of the second spiral wiring are dispersed on the first surface and the second surface of the insulating substrate.

7. The antenna module of claim 6, wherein one or more of the coil strands of the innermost turns are disposed on both the first surface and the second surface of the insulating substrate and are connected to each other in parallel.

8. The antenna module of claim 7, wherein a line width of the coil strands connected to each other in parallel is narrower than a line width of remaining ones of the coil strands.

9. The antenna module of claim 3, wherein an overall width of the first spiral wiring is equal to an overall width of the second spiral wiring.

10. The antenna module of claim 1, further comprising a magnetic portion disposed on one surface of the insulating substrate, wherein the connecting part is disposed in a position that does not face the magnetic portion.

11. The antenna module of claim 1, wherein one or more turns of the first spiral wiring and one or more turns of the second spiral wiring are connected to each other in parallel.

12. The antenna module of claim 11, wherein an innermost turn of the first spiral wiring and an innermost turn of the second spiral wiring are connected to each other in parallel, and
an outermost turn of the first spiral wiring and an outermost turn of the second spiral wiring are connected to each other in parallel.

13. The antenna module of claim 11, wherein a line width of the coil strands of the turns of the first spiral wiring and the second spiral wiring connected to each other in parallel is narrower than a line width of the coil strands of remaining turns of the first spiral wiring and the second spiral wiring.

14. An electronic device comprising:
a wiring portion comprising communications wiring disposed on opposite surfaces of an insulating substrate; and
a magnetic portion coupled to one surface of the wiring portion,
wherein the communications wiring comprises:
a spiral wiring comprising a plurality of coil strands spaced apart from each other; and
a connecting part electrically connecting the coil strands to each other and disposed at a position where the connecting part does not face the magnetic portion.

15. The electronic device of claim 14, wherein the spiral wiring is formed by a first spiral wiring disposed on a first surface of the insulating substrate and a second spiral wiring disposed on a second surface of the insulating substrate,
an inner end portion of the first spiral wiring and an inner end portion of the second spiral wiring are connected to each other through an interlayer connection conductor disposed in the insulating substrate, and
the communications wiring further comprises:
a first connection pad;
a second connection pad;
a first lead wiring connecting an outer end portion of the first spiral wiring to the first connection pad; and
a second lead wiring connecting an outer end portion of the second spiral wiring to the second connection pad.

16. The electronic device of claim 15, wherein an innermost turn of the first spiral wiring and an innermost turn of the second spiral wiring are connected to each other in parallel.

17. An antenna module comprising:
an insulating substrate; and
a plurality of coil strands forming a spiral wiring on the insulating substrate beginning on a first surface of the insulating substrate and ending on a second surface of the insulating substrate, the plurality of coil strands not being electrically connected to each other within the spiral wiring and being electrically connected to each other outside the spiral wiring.

18. The antenna module of claim 17, wherein the spiral wiring comprises:
a first spiral wiring disposed on the first surface of the insulating substrate; and
a second spiral wiring disposed on the second surface of the insulating substrate,
the antenna module further comprises:
interlayer connection conductors disposed in the insulating substrate and electrically connecting inner end portions of the plurality of coil strands of the first spiral wiring to inner end portions of the plurality of coil strands of the second spiral wiring;
a first connection pad;
a second connection pad;
a first lead wiring electrically connecting outer end portions of the plurality of coil strands of the first spiral wiring to the first connection pad; and
a second lead wiring electrically connecting outer end portions of the plurality of coil strands of the second spiral wiring to the second connection pad,
wherein either
the first connection pad electrically connects the plurality of coil strands of the first spiral wiring to each other, and the second connection pad electrically connects the plurality of coil strands of the second spiral wiring to each other,
or
the first lead wiring comprises a first connecting part electrically connecting the plurality of coil strands of the first spiral wiring to each other in the first lead wiring, and the second lead wiring comprises a second connecting part electrically connecting the plurality of coil strands of the second spiral wiring to each other in the second lead wiring.

19. The antenna module of claim 18, wherein a number of turns of the first spiral wiring is equal to a number of turns of the second spiral wiring,
an outer periphery of the first spiral wiring aligns with an outer periphery of the second spiral wiring through the insulating substrate, and
an inner periphery of the first spiral wiring aligns with an inner periphery of the second spiral wiring through the insulating substrate.

20. The antenna module of claim 17, further comprising a magnetic portion disposed on the first surface or the second surface of the insulating substrate or facing the first surface or the second surface of the insulating substrate,
wherein the plurality of coil strands are electrically connected to each other outside the spiral wiring at a position that does not face the magnetic portion.
